(19) United States
(12) Patent Application Publication
(10) Pub. No.: US 2002/0147913 A1
(43) Pub. Date: Oct. 10, 2002

(54) Tamper-proof mobile commerce system

(76) Inventor: William Wai Lun Yip, Ontario (CA)

Correspondence Address: Robert K. Tendler, 65 Atlantic Avenue, Boston, MA, 02110, US

(21) Appl. No.: 09/829,367

(22) Filed: Apr. 9, 2001

(51) Int. Cl. H04L 9/00

(52) U.S. Cl. 713/184; 705/64

(57) ABSTRACT

A wireless phone or other wireless device is utilized to authorize debit transactions from a bank or financial institution in a secure manner in which a one-time meaningless transaction number is displayed to the user at the point of purchase terminal, which the user enters into his wireless phone or other wireless device to authorize the transaction. In one embodiment, the individual uses the device to call the mobile commerce server, and is identified by means of a Wireless Application Protocol ID, or equivalent. The user then enters a PIN number to authorize the transaction. The individual may also select from the wireless device the particular bank from which the debit is to come. In one embodiment, the mobile phone user then goes to the cash register and tells the clerk that this is a mobile commerce transaction. The transaction amount and the identity of the store is transmitted to the mobile commerce server, and the mobile commerce server transmits back to the register a one-time only transaction number which is displayed to the individual or automatically transmitted to the user's wireless device. The individual views the transaction number at the register and enters this number via the keypad into the wireless device if it has not already been automatically transmitted. The transaction number along with the PIN number or personal ID number and selected bank is then transmitted to the mobile commerce server, which authorizes and completes the sale, the fact of which is then transmitted back to the register. In so doing, casual observers will, if anything, obtain the transitory transaction number, which is meaningless. Moreover, any apparatus at the register, which would normally be utilized to transact the business, even if tampered with, would have no effect on the subject system since the apparatus, which initiates this transaction, is the wireless device, which is in the possession of the user as opposed to unscrupulous store employee or other miscreant.

### FIELD OF INVENTION

This invention relates to debit transactions and more particularly a tamper-proof mobile commerce system utilizing a wireless device.

### BACKGROUND OF THE INVENTION

As is well-known, credit or debit transactions are made through the utilization of credit cards or debit cards which are swiped through a reader at a register tip or cashier's terminal in order to authorize the payment of a purchase from a predetermined bank or financial institution.

Other cards with intelligence contained in the card, called smartcards, are often utilized at various ATM machines or other terminals to be able to withdraw cash or to effectuate some other debit transaction.

In the case of debit cards, key to the authorized use of such devices is the use of a so-called “PIN” which is a personal identification number that is known only to the individual seeking to cause the debit transaction to occur. For example, in a common debit card transaction, the merchant rings up the sale as usual, and the customer uses a specially provided piece of equipment to swipe his or her card, enter a PIN, and choose the bank from which the debit is to occur. The debit request is passed through, for example, either the Visa or MasterCard network, with the customer's card and PIN being transmitted to the bank where account funds are verified by the financial institution. Upon verification, the purchase is completed and funds are disbursed.

In supermarket checkouts, ATM machines, and in other places where PINs are often times required, casual observers can often times observe the PIN utilized by watching the individual key in the PIN at a keypad at the terminal. The result is that debit cards can be effectively stolen without having possession of the debit card by obtaining the debit card number and associating it with a particular PIN.

Oftentimes what happens in stores is that unscrupulous store employees will, through access to the card reader or other devices, be able to draw down the individual's account or debit it through using the several pieces of information which are required, namely the account number, the person's name and the PIN.

The above is often called “shoulder surfing” and results in losses to the individual, calculated by the industry in the millions of dollars each year. While security systems are presumably in place to prevent the unauthorized use of a credit card or debit card, such systems can fail if those seeking to defeat the system either observe the payment card being used or have control of the equipment utilized to read the card.

As for credit cards, once the card is stolen or the account number and name is known, it is relatively easy to use the card or make purchases with the name, credit card number and expiration date.

Whether using a credit card or debit card, the payments are made in a process in which critical information as to the identity of the individual, and a personal ID number or an access PIN are utilized in authorizing the debit to be made from the bank or other financial institution.

More recently, wireless technologies have provided the ability for one having a wireless transmitter, such as a cellular phone, to be able to transact business, including surfing the internet, and can provide personal and banking information. One such example of a technology that enables such convenience is the Bluetooth™ protocol provided by the Bluetooth special interest group. It is essentially a cable replacement technology that uses a specific radio frequency range to allow Bluetooth-enabled devices to communicate wirelessly over short distances. People utilizing the Bluetooth technology can utilize a wireless phone to, for instance, purchase soft drinks from a vending machine, pay parking meters, or, in fact, activate a juke box to play a particular song and have it charged to the individual's account.

With Bluetooth or similar technologies, there is also the potential to utilize the wireless technology to provide debiting of bank accounts in the electronic payment market.

While Bluetooth technology could enable users to complete debit transactions using their wireless phones, a disadvantage of the Bluetooth technology is that specialized hardware is required. In the vending machine scenario, a specialized receiver would have to be built into the vending machine, which is Bluetooth compatible. Moreover, the wireless devices used to achieve this transaction would need to contain a special Bluetooth chip. Thus, in a debit transaction, each cash register or debit terminal would need a Bluetooth receiver. While the Bluetooth-enabled phones could eliminate the risk of an observer observing a PIN, in order to build out such a Bluetooth system, much investment and long lead times are necessary.

The subject invention is a means of achieving debit and credit transactions that would have the security and convenience advantages of the technologies such as Bluetooth, but not its disadvantages.

### SUMMARY OF THE INVENTION

In order to provide that a user can debit his or her bank account with complete security and without having the PIN being observable at the terminal at which the transaction takes place, in one embodiment the person seeking to debit the account is provided with a wireless transmitter and transitory transaction number which is provided from a mobile commerce server for each transaction and changes with each transaction. The user then keys this rather meaningless transitory number by using the keypad on the wireless transmitter, which identifies the particular transaction and is good for no other transaction. Alternatively the transitory transaction number can be automatically inputted into the wireless transmitter at the transaction site using short-distance wireless transmission technology such as Bluetooth.

Thus, even if an observer observes the transaction number, since it is a one-time use only number, it will provide no particularly significant information to those seeking to provide further debit transactions.

Thus, in the subject invention, there is a change in the type of information that the user needs to enter as well as the equipment used to enter it. In conventional debit payment systems, shoppers enter their confidential bank information by swiping their bank card and entering their PIN into a terminal at the cash register where privacy cannot always be guaranteed. Because the terminal is in the possession of the store, the shopper has no way of knowing whether the terminal has been tampered with.

Thus, in the subject system the transaction is made secure because not only is no card involved, but when the shopper's sale is rung into the cash register, a unique transaction identification number is generated by the debit payment system and is displayed for the shopper. The shopper then enters the transaction identification number into his internet enabled cell phone in one embodiment.

The cell phone relays the transaction identification number along with the shopper's PIN information to the debit payment system. Not only is the previously sensitive transaction information now entered using the shopper's own equipment, but the nature of the information has changed. No longer is sensitive information provided by the user in terms of a PIN that can be observed. Rather, that which can be observed is only the transaction ID which is meaningless outside the context of the particular transaction. Note also that the PIN does not contain any bank information. Thus, even if the PIN is observed and even if the transaction ID is observed, the person's account number is in no way available via the transaction. It is noted that the person's bank account number or card number is, of course, in the prior art observable either from looking at the credit card, tampering with a card reader, or having a copy of the credit card receipt.

Each user is uniquely identified to the mobile commerce system by a WAP ID or equivalent. It is noted that for wireless phones, each phone has an electronic serial number or ESN. The ESNs are not given out in Internet requests, but are instead translated into a unique WAP ID or equivalent in other non-WAP protocols.

The advantages of the above-noted mobile commerce solution are that it does not require special equipment and hardware thus eliminating the possibility of fraud through the equipment owned or operated by the store. The customer in this case has a trusted piece of equipment, namely his or her own mobile phone or wireless device, through which, by means of the WAP ID or equivalent, they are uniquely identified to the mobile commerce server. Moreover, because the mobile commerce solution requires only software modifications and, therefore, can leverage existing debit transaction equipment, stores can offer this method of paying by wireless device by keeping their existing equipment options. Additionally, a plastic debit/credit card is no longer required, eliminating the chance for loss, theft or fraud. Moreover, for debit cards users are no longer restricted to having to enter their PINs at the cash register. They can log into the service and enter the PIN in any part of the store where they have the desired privacy. Finally, the information that users enter is no longer sensitive in the same way as the payment card information. The transaction ID that is used is meaningless outside the transaction and has no value even if it were captured.

Note that the financial institution as used herein can be a bank, a credit or debit card company or even a store's own credit card facility.

In summary, a wireless phone or other wireless device is utilized to authorize debit transactions from a bank or financial institution in a secure manner in which a one-time meaningless transaction number is displayed to the user at the point of purchase terminal, which the user enters into his wireless phone or other wireless device to authorize the transaction. In one embodiment, the individual uses the device to call the mobile commerce server, and is identified by means of a Wireless Application Protocol ID, or equivalent. The user then enters a PIN number to authorize the transaction. The individual may also select from the wireless device the particular bank from which the debit is to come. In one embodiment, the mobile phone user then goes to the cash register and tells the clerk that this is a mobile commerce transaction. The transaction amount and the identity of the store is transmitted to the mobile commerce server, and the mobile commerce server transmits back to the register a one-time only transaction number which is displayed to the individual or automatically transmitted to the user's wireless device. The individual views the transaction number at the register and enters this number via the keypad into the wireless device if it has not already been automatically transmitted. The transaction number along with the PIN number or personal ID number and selected bank is then transmitted to the mobile commerce server, which authorizes and completes the sale, the fact of which is then transmitted back to the register. In so doing, casual observers will, if anything, obtain the transitory transaction number, which is meaningless. Moreover, any apparatus at the register, which would normally be utilized to transact the business, even if tampered with, would have no effect on the subject system since the apparatus, which initiates this transaction, is the wireless device, which is in the possession of the user as opposed to unscrupulous store employee or other miscreant.

### BRIEF DESCRIPTION OF THE DRAWINGS

These and other features of the subject invention will be better understood in conjunction with the Detailed Description in connection with the Drawings of which:

FIG. 1 is a diagrammatic representation of a scenario in which a user authorizes a debit through the utilization of a debit card and a PIN entry device, which is observable;

FIG. 2 is a diagrammatic representation of the utilization of the subject system in which a transaction ID is transmitted back to the register terminal which is utilized by the customer to authorize the debit;

FIG. 3 is a block diagram of the subject system illustrating the flow of events leading to an authorized debit;

FIG. 4 is a front view of a wireless phone showing the phone display and an indication of what account is to be debited;

FIG. 5 is a front view of the wireless phone of FIG. 4, showing the entry of a PIN in masked form;

FIG. 6 is a front view of the wireless phone of FIG. 4, showing an on-screen prompt for the entry of a PIN;

FIG. 7 is a front view of the wireless phone of FIG. 4, showing the request to enter the transaction number;

FIG. 8 is a front view of the wireless phone of FIG. 4, the transaction ID number entered;

FIG. 9 is a front view of this wireless phone of FIG. 4, showing the amount of the payment to be authorized; and

FIG. 10 is a front view of the phone of FIG. 4 showing the screen indicating a completed transaction.

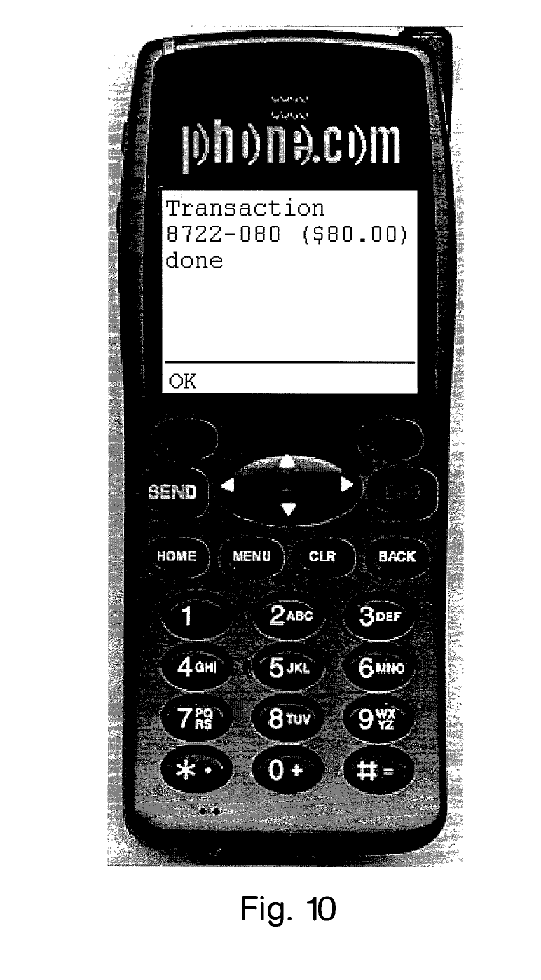

### DETAILED DESCRIPTION

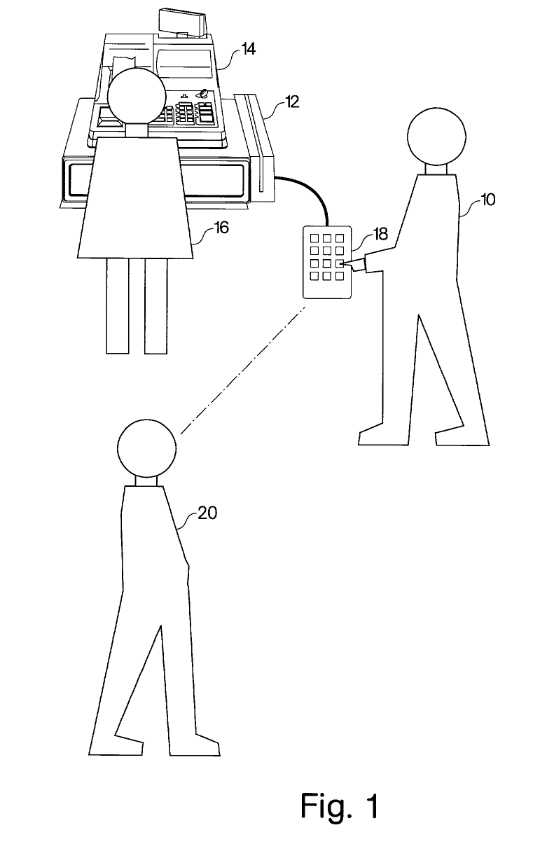

Referring now to FIG. 1, while the subject system has application to both debit and credit card transactions, the debit card transaction is first described in this scenario, an individual can cause his or her debit card to be read by a card reader 12 at a register 14 attended by a clerk 16. In order for the desired transaction to be authorized, a PIN entry device 18 is provided at the register with the PIN being entered by individual 10. As can be seen, an observer 20 can see the individual entering the PIN and make mental note of it. Having the PIN and also some indication of the card number, the observer can then cause debits to be made on the individual's account. As mentioned hereinbefore, if the observer is a store employee or in collusion with a store employee, then obtaining the card number and marrying it with the PIN is a relatively easy task. An observer and an employee working in concert can therefore steal money from the accounts of many customers without the customer knowing that it is occurring.

It is also possible that a copy of the register receipt or credit card debit receipt can be obtained by one of the employees and correlated with the PIN that is observed.

While the above scenario is typical of an in-store debit card transaction, ATM transactions have essentially the same elements. Assuming that an inside employee can ascertain the debit card number, an observer can then observe the PINs being entered and correlate them with a particular card. Moreover, even if there is no inside employee at the ATM or in charge of the ATM, an observer can observe the debit card number from the debit card before it is inserted into the card slot.

While PIN-oriented security systems were designed to prevent against the above capture of the authorization information, it, nonetheless occurs indicating that the present PIN-oriented systems are not as secure as originally thought.

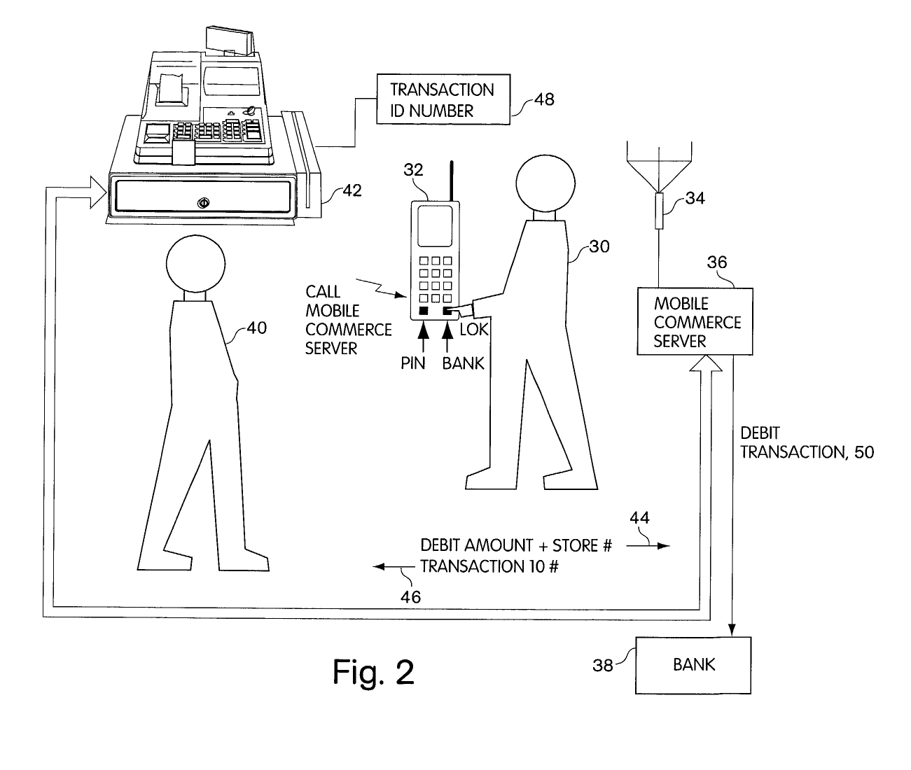

Referring now to FIG. 2, in order to provide a secure transaction, an individual 30 utilizes a wireless phone 32 or other wireless device, which is connected via cell site 34 to a mobile commerce server 36. When the individual seeks to authorize a debit to his bank account at bank 38, a clerk 40 at a register 42 keys in the amount of purchase which is transmitted along with the store numbers illustrated by arrow 44 to mobile commerce server 36. The result is that the mobile commerce server transmits back a transaction ID number as illustrated by arrow 46 to register 42 where the transaction number is displayed at display 48 to the one seeking to authorize the debit.

Prior to the transaction, the mobile commerce server is made aware that the individual wishes to make a purchase by having the individual communicate with the mobile commerce server at some predetermined time before the actual transactions take place. At that time, the user transmits his PIN and the particular bank he wishes to use as the debiting authority. When the user now at the register tip sees the transaction ID number, he or she keys it into his wireless phone at which point it is transmitted to the mobile commerce server which then causes a debit transaction, here illustrated at 50 to occur at bank 38. Upon the correlation of the transaction number and the PIN as well as the bank, an authorization, here illustrated at 52, is sent back to register 42 indicating a completed transaction.

In this manner, the user is able to complete a debit transaction from his or her bank without having to use a debit card. Note that the only information necessary to be transmitted is the user's PIN and the bank or other financial institution from which the debit is to be made and that this is done in one embodiment prior to the individual arriving at the register.

In order to accomplish this transaction, the user knowing that he or she wishes to complete a transaction, calls up the mobile server via the wireless device and transmits the PIN and the bank identification to the mobile server. Thereafter, there is a timeout period in which the transaction must be made in order for the transaction to be authorized. For instance, a timeout period of five minutes would not seem to be unreasonable to have the user alert the mobile commerce server that a transaction is coming and then go to the checkout counter and go through the checkout process.

In the subject invention, an electronic personal identification number is used to identify the individual to the mobile commerce server. In one embodiment this is a WAP ID. When a WAP enabled phone is used, the WAP ID is unique to the phone's ESN and can be used to identify the authorized individual each time the phone is used. In other non-WAP protocols, an equivalent ID is used.

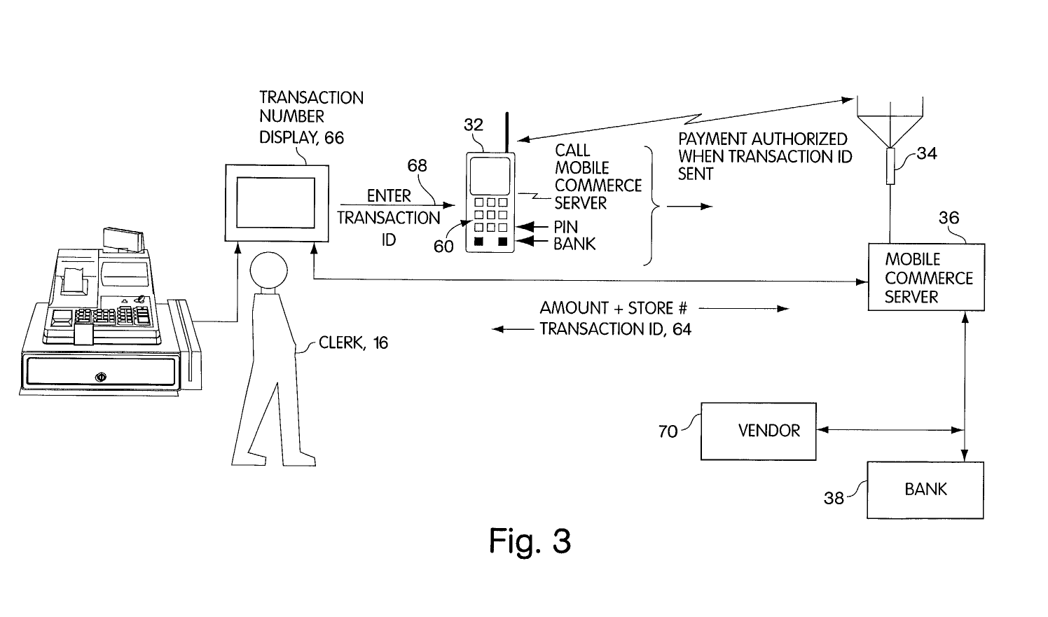

Referring now to FIG. 3, in general in one embodiment for debit cards a wireless phone 60 is utilized to communicate with mobile commerce server 36 through cell site 34 in which a PIN is entered on keypad 60. During the initial transaction in which the wireless phone communicates with the mobile commerce server, the user is identified to the mobile commerce server by means of a WAP ID or equivalent. After the user has authorized the transaction by entering his PIN, the mobile commerce server transmits back to the wireless phone those particular banking institutions, which are associated with the WAP ID or equivalent. Thereafter, the user specifies via keypad 60 that bank or financial institution, which is to be, utilized in the debit transaction, in this case bank 38. During the particular timeout period, the individual seeks to complete the transaction and the amount and store number as illustrated at 62 are transmitted to the mobile commerce server, whereas the aforementioned transaction number here illustrated at 64 is transmitted back to a register 66 where the transaction ID number is made available to the wireless phone user as illustrated at 68 then the transaction number is physically entered into the keypad or is automatically transmitted from the register to the wireless phone. Upon the transmission of the transaction ID number to the mobile commerce server, a debit is made from the user's bank account and the funds are transferred to the vendor here illustrated at 70.

In one scenario, the Mobile Commerce System provides a service to financial institutions or third party debit payment operators by offering this mode of payment. Member merchants of these financial institutions are debit payment operators who use the mobile commerce service automatically to gain the ability to offer payment by wireless phone to their customers. Customers may have multiple accounts with one or more member banks and as mentioned above, have the choice of paying for many of these accounts.

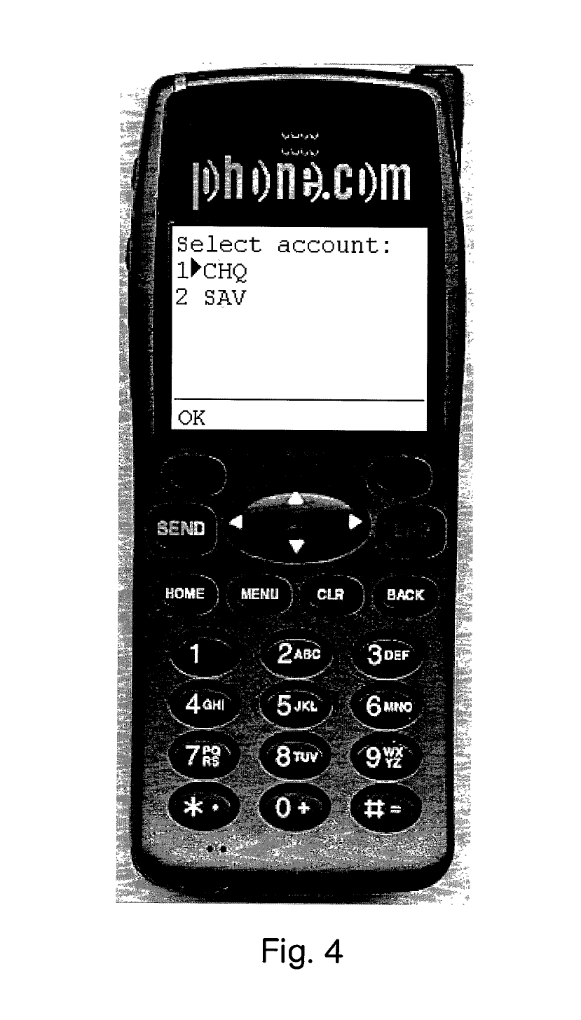

In one debit scenario, a customer has just finished shopping at, for instance, a supermarket. The customer takes out his cell phone and dials a pre-programmed mobile commerce website. The connection completes and the phone displays the accounts that the user can choose from. This is illustrated in FIG. 4.

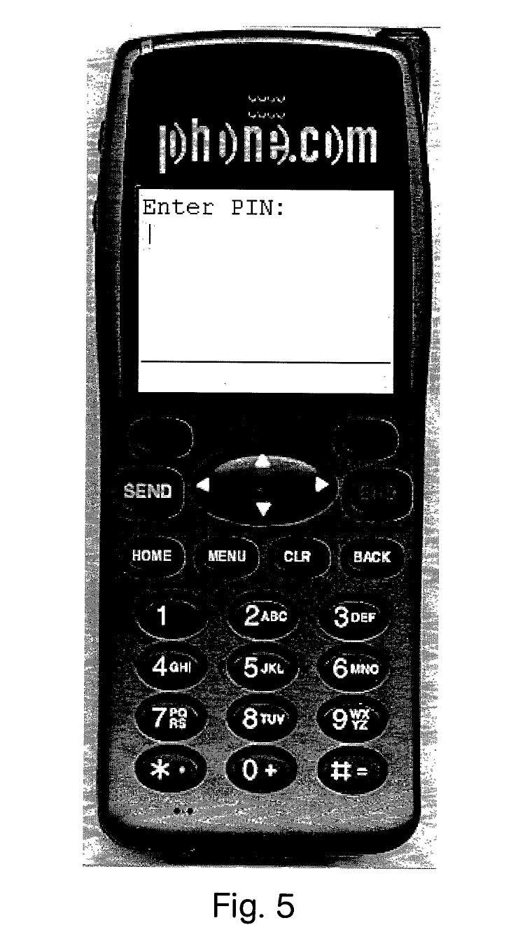

When the user decides to pay from a checking account, the user selects “CHK” and presses OK. Immediately, the user is prompted as shown in FIG. 5 to enter a PIN for that account. For maximum security, the user is cautioned to use a quiet aisle in the supermarket to complete the login process and double check to make sure no one is close enough to watch the entry of the PIN.

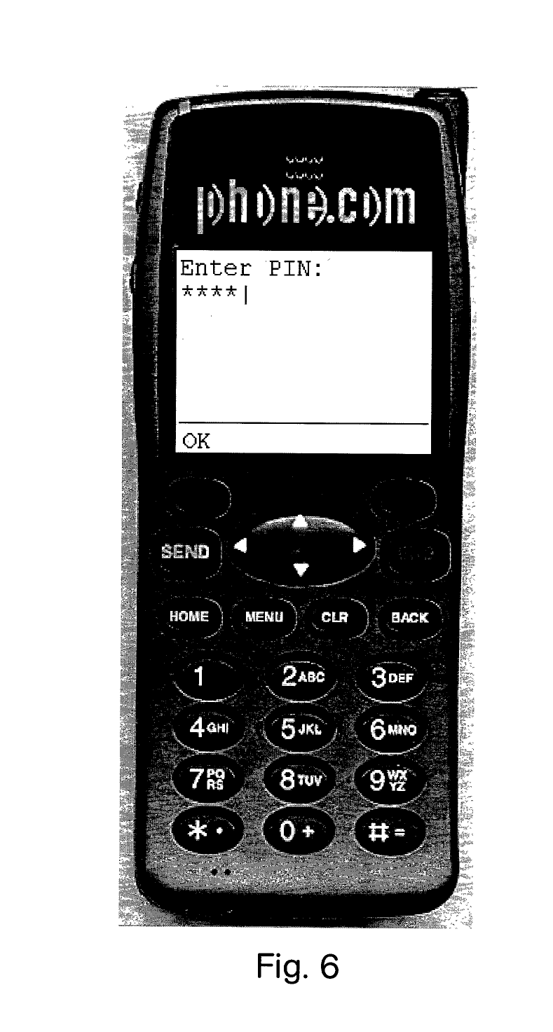

Referring to FIG. 6, as the PIN is entered, the display masks the PIN by displaying only an asterisk for each number that is entered. When the PIN has finally been entered, the user presses OK. The display then confirms which account has been chosen and prompts the user to enter a transaction number. At this point, the customer proceeds to the cash register knowing that he or she has five minutes before the authorization times out.

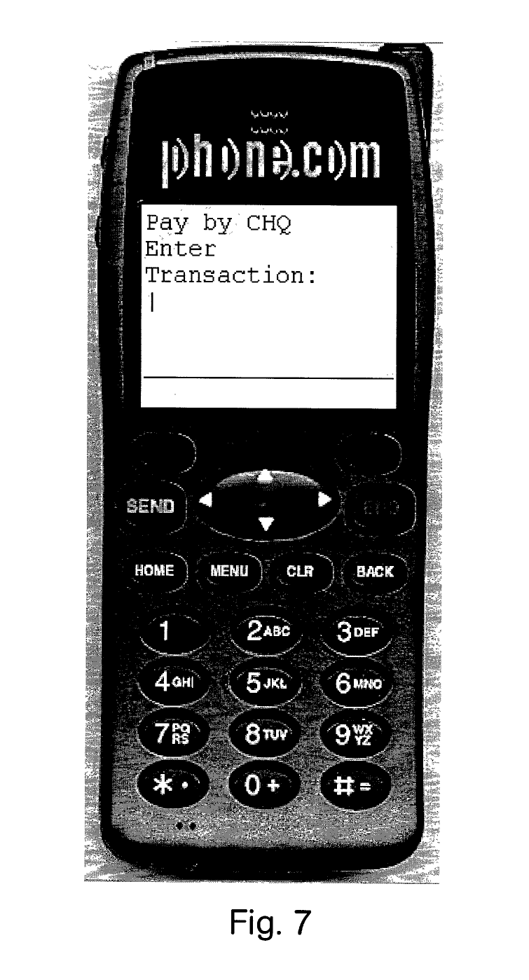

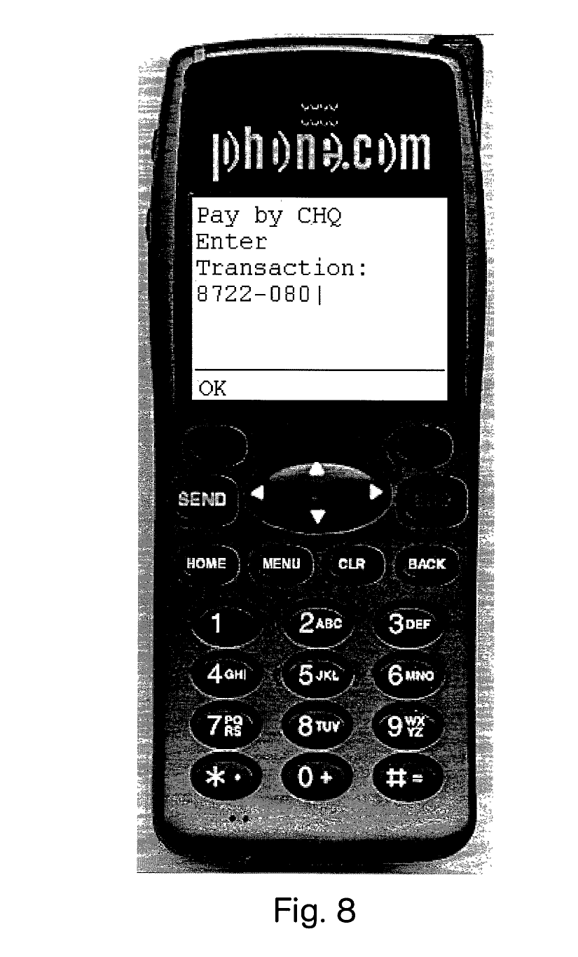

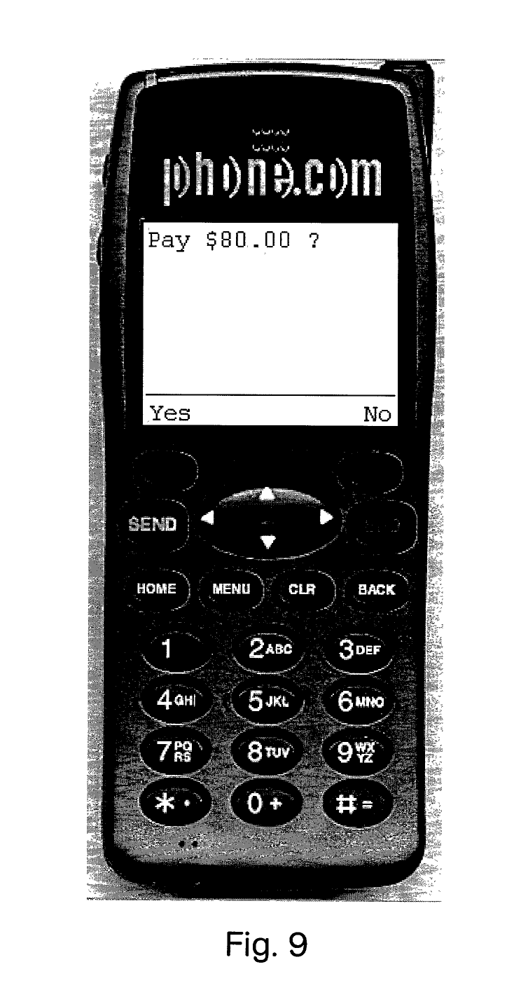

Referring to FIG. 7, at the cash register, the register rings up the purchases and asks how the customer would like to pay. The customer responds “by mobile commerce” and the cashier punches a key on the debit payment terminal. After a few seconds, a transaction ID appears on the terminal screen which prompts the user to enter this number into the phone number and press OK. This entry is shown in FIG. 8. As illuminated in FIG. 9, the mobile server causes the phone to display the transaction amount and asks for confirmation of payment. When the user presses OK, a final confirmation message appears indicating that the amount was paid.

The cash register then displays a similar message confirming that the transaction was completed successfully. Pressing “end” on the phone disconnects from the mobile commerce server at which point the customer can take the receipt and the purchases and leave the store.

In an alternative scenario for credit card purchases and as an alternative to current store credit cards, instead of providing credit cards which the customer swipes in card readers, participating stores can offer their customers access to their store accounts using their wireless phones. Assuming that one has finished shopping at, for instance, a discount chain store, one can take out one's cell phone and dial the store's website. The user's WAP ID or equivalent identifies him to the store's website. The connection completes and the user is prompted for the account's PIN. Choosing a quiet spot in the store, one makes sure that no one else is close enough to watch before the PIN is entered.

If PINs are used, once the PIN has been entered, the display masks the PIN by displaying only asterisks for each number that is entered. When having finished entering the PIN, the individual presses OK, at which point, the display prompts the entry of a transaction number. Heading for the cashier, one knows that he or she has five minutes before the authorization times out. Having proceeded to the cash register, the cashier rings up purchases and asks how the customer would like to pay. This is in essence a mobile commerce scenario described above with a message displaying the transaction amount and asking the individual to confirm payment which appears on the individual's phone where there is a screen capture of the amount confirmation.

When the customer presses OK, a message is displayed indicating that the amount was paid as displayed on-screen indicating that the transaction is complete. As before, there is a display at the register of a similar message that the transaction has been completed. Pressing “End” on the wireless phone disconnects from the service.

What will be appreciated is that a cardless transaction has been completed which is secure and less prone to fraud than the use of either debit cards and associated PINs or credit cards with a handwritten signature.

This mobile commerce server can be utilized anywhere in which a debit is to be authorized from a financial institution whether or not it is in the form of a debit transaction or a credit card transaction. It can be used with current software and equipment normally found at registers or can be included in diverse devices where it is important that a PIN not be observable. Of course, not having a credit card masks the bank account and its owner from detection.

While the system is most readily adaptable at checkout counters and the like, this mobile commerce server can also be utilized with vending machines, parking meters, or other e-commerce transactions in which secure authorization is required. Thus, for instance, an individual's own computer could be used with increased security when performing an e-commerce transaction with one's own computer displaying the transaction number driven by a mobile commerce server, in this case, coupled to the internet.

This is because the identity of the bank and the individual is transmitted by another modality, namely, the wireless device. Thus, the individual's identity and bank are not available on the Internet as is the case with normal credit card transactions.

What is now presented is a program listing in Java, with the program to be run on WebLogic from BEA Systems:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A system for securely authorizing a disbursement transaction from a financial institution which has funds under the control of an individual, comprising
a financial institution adapted to disburse funds upon authorization of an individual to a vendor;
a terminal at said vendor for initiating a disbursement transaction and for transmitting to said financial institution the amount of said disbursement the identity of said terminal;
a communication channel from said financial institution to said terminal for transmitting a transaction identification number to said terminal;
a display at said terminal for displaying said transaction identification number; and
a wireless transmitter in the possession of said individual for transmitting a predetermined code identifying said individual and said displayed transaction identification number to said financial institution, the receipt of which by said financial institution causing authorization of disbursement of said amount.

2. The system of claim 1, wherein said predetermined code is a personal identification number.

3. The system of claim 1, wherein said predetermined code is the electronic serial number of said wireless transmitter.

4. The system of claim 1, wherein said wireless transmitter includes a selector for selecting which financial institution is the one from which said disbursement is to be made, said wireless transmitter transmitting said selected financial institution identification to the selected financial institution.

5. The system of claim 4, wherein said selected financial institution identification is transmitted with said predetermined code.

6. The system of claim 5, wherein said predetermined code is entered into said wireless transmitter and is transmitted to said financial institution prior to the individual arriving at said terminal, whereby the entry of said predetermined code can be made in secret.

7. The system of claim 6, and further including a transaction timeout and wherein said authorization from said wireless transmitter must arrive before said timeout to authorize said disbursement.

8. A method for securely authorized disbursement of funds from a financial institution comprising the steps of:
providing a wireless transmitter to an individual seeking the disbursement;
transmitting a transaction identification number to the site of the authorization;
entering the transaction identification number into the wireless transmitter; and
transmitting the entered number to the financial institution for authorization of the disbursement.

9. The method of claim 8, wherein the transaction identification number is unique to the transaction and changes from one transaction to the next.

10. The method of claim 8, wherein the step of transmitting includes transmitting a predetermined code identifying the individual authorizing the disbursement.

11. The method of claim 10, wherein the predetermined code is entered into the wireless transmitter at a location remote from the location at which the individual enters in the transaction identification number, both code and transaction number being necessary to authorize disbursement from the financial institution.

12. The method of claim 8, wherein the transmitting step includes transmitting a financial institution identification number for selecting from which financial institution the disbursement is to be made.

13. The method of claim 2, wherein the predetermined code and the financial institution number are entered into the wireless transmitter at a location remote from the location at which the individual enters in the transaction number.

14. The method of claim 8 and further including the step of authorizing the disbursement only if the authorization is made within a predetermined time after transmission of the predetermined code.
